(19) United States
(12) Patent Application Publication
(10) Pub. No.: US 2024/0251015 A1
(43) Pub. Date: Jul. 25, 2024

(54) SYSTEM AND METHOD FOR MANAGING MEDIA AND SIGNALING IN A COMMUNICATION PLATFORM

(71) Applicant: Twilio Inc., San Francisco, CA (US)

(72) Inventors: Brian Tarricone, San Francisco, CA (US); Yu Zhang, San Francisco, CA (US)

(21) Appl. No.: 18/625,906

(22) Filed: Apr. 3, 2024

Related U.S. Application Data
(63) Continuation of application No. 16/259,405, filed on Jan. 28, 2019, now Pat. No. 11,973,835.
Application No. 16/259,405 is a continuation of application No. 15/687,054, filed on Aug. 25, 2017, now Pat. No. 10,212,237.
Application No. 15/687,054 is a continuation of application No. 14/793,284, filed on Jul. 7, 2015, now Pat. No. 9,774,687.
(60) Provisional application No. 62/021,633, filed on Jul. 7, 2014.

(51) Int. Cl. H04L 67/141; H04L 9/40; H04L 65/1033; H04L 65/1045; H04L 65/1069; H04L 65/1104; H04L 65/612; H04L 69/24

(52) U.S. Cl. CPC H04L 67/141; H04L 9/40; H04L 65/104; H04L 65/1045; H04L 65/1069; H04L 65/1104; H04L 65/612; H04L 69/24

(57) ABSTRACT

Systems and methods for communicating media between a client and a media server. Responsive to a communication initiation received by a signaling controller from a client system, the signaling controller invites a media server by providing an invitation to the media server. The media server is bridged with the client system by controlling a media proxy service to establish a media proxy between the client system and the media server by using client media parameters of the first communication initiation and media server media parameters provided by the media server responsive to the invitation. Media is communicated between the external client system and the media server by using the established media proxy.

### CROSS-REFERENCE TO RELATED APPLICATIONS

This application is a continuation of U.S. patent application Ser. No. 16/259,405, filed Jan. 28, 2019, which is a continuation of U.S. patent application Ser. No. 15/687,054, filed Aug. 25, 2017, which is a continuation of U.S. patent application Ser. No. 14/793,284, filed Jul. 7, 2015, which claims the benefit of U.S. Provisional Application Ser. No. 62/021,633, filed on Jul. 7, 2014, all of which are incorporated in their entirety by this reference.

### TECHNICAL FIELD

This invention relates generally to the communication platform field, and more specifically to a new and useful system and method for managing media and signaling in a communication platform in the communication platform field.

### BRIEF DESCRIPTION OF THE FIGURES

FIG. 1 is schematic diagram of a system of a preferred embodiment;

FIG. 2 is a process block diagram of a method of a preferred embodiment;

FIG. 3 is schematic diagram of a system of a preferred embodiment;

FIG. 4 is a process block diagram of a method of a preferred embodiment;

FIG. 5 is a communication sequence diagram of a method of a preferred embodiment;

FIG. 6 is an architecture diagram of a system of a preferred embodiment; and

FIG. 7 is an architecture diagram of a system of a preferred embodiment.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. System for Managing Media and Signaling

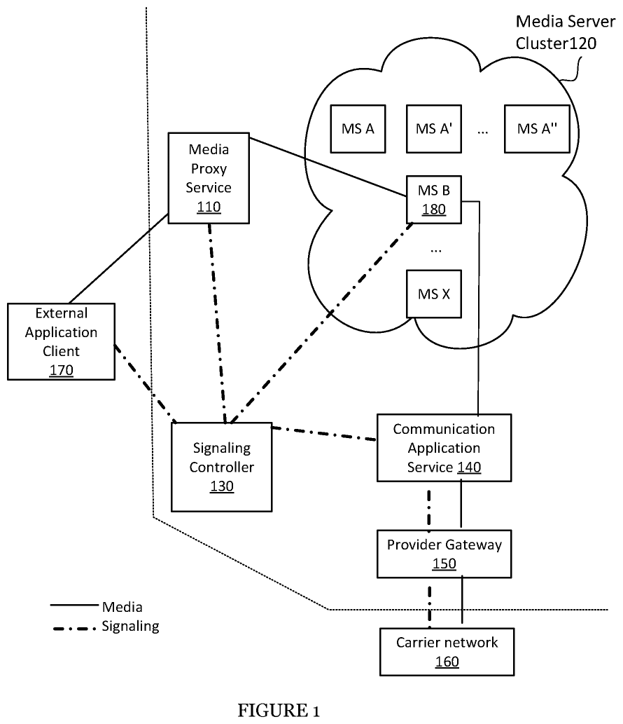

As shown in FIG. 1, a system for managing media and signaling in a communication platform can include a media proxy service 110, a media server cluster 120, and at least one signaling controller 130. The system functions to separate signaling and media into two services that cooperatively support media communications. The system is a platform architecture that can offer flexibility in media-processing related technology, in scaling capacity of the platform, and improved tolerance to system failure. As opposed to depending on a monolithic signaling and media stack, media and signaling can operate in cooperation but independently. Further the architecture of the media and signaling can provide benefits relating to multi-tenancy, security, per account/per-subaccount metering and billing, scalability, programmatic integration, regionally distributed availability, and/or other suitable benefits.

The system is preferably used within a communication platform. The communication platform can support synchronous voice communication (e.g., IP calls, PSTN calls, conference calls, etc.), synchronous video communication (e.g., video chat, video conferencing, screen sharing, etc.), immersive media experiences (e.g., virtual reality, 3D imagery), and/or other suitable types of communication. The system may additionally be used in combination with application specific logic. In one variation, account directed application logic could be used to direct control logic of a communication session such as in the application communication platform described in U.S. Pat. No. 8,306,021, issued on 6 Nov. 2012, which is incorporated in its entirety by this reference. The system may additionally or alternatively be used in a SIP trunking service or other suitable VoIP communication service such as a system employing the signaling and media functionality of the system of U.S. patent application Ser. No. 14/208,920 filed 13 Mar. 2014, which is incorporated in its entirety by this reference. The system is preferably used in a multi-tenant communication system, where multiple accounts/users share use of common infrastructure. The system may have particular benefits to use in a multi-tenant system as the system can support dynamic scaling, interfacing with outside client infrastructure, and supporting a variety of media service variations, but the system may alternatively be used in a single-tenant communication system. In one preferred use-case, the system can be used to provide more resilient and flexible media services within a communication platform. In another preferred use-case, the system can be used to provide a media service as a platform offering to outside applications and services. A media service as a platform system can allow outside applications or services to utilize media and signaling related infrastructure offered within the platform without having build out custom solutions. The media service as a platform system preferably addresses issues related to offering such a service.

The media proxy service 110 of a preferred embodiment functions as the interface to the media services (e.g., media services of the media server cluster 120). The media proxy service 110 is preferably a proxy to the actual media processing services of the media server cluster 120. Other services and consumers of the media service preferably communicate with the media server cluster through the media server cluster 120. The media proxy service 110 can be a single component but is preferably a plurality of proxy services that can be used interchangeably. The media proxy service 110 may additionally include a hierarchy of media proxy servers. The media proxy servers can be regionally distributed to serve different geographic regions, and relay media through a base media proxy server (e.g., a main region which contains a media server cluster 120). The base media proxy server can be instantiated in a main regional computing infrastructure location, and may include additional capabilities to interface with central or region specific resources such as canonical database systems.

The media proxy service 110 is preferably hosted in a distributed computing platform but may alternatively be hosted in a central site. The set of proxy servers supporting the media proxy service 110 are preferably referenced through one or more static networking addresses, more preferably a static IP address and/or port. The static address functions to enable client applications to reliably set networking restrictions to allow communication with the media proxy service 110. As opposed to a system with a cluster of media servers that constantly is updated, the media proxy service 110 can provide a reliable entry portal of media communication. The machines of the media proxy service 110 can have Enterprise Integration Patterns (EIPs). A client service, which preferably communicates over internet protocol, may whitelist a set of IPs and ports to which a media proxy service 110 will operate over. More preferably, the EIPs can be used by customers to enable whitelisting and/or prioritization of RTP traffic between clients and the system. Additionally, particular entities (e.g., account, sub-accounts, and the like) can be assigned particular sub-sets of networking addresses, which can work in combination with security policy engine. Additional security can further be used in communication such as including of authentication tokens to validate inbound/outbound communication. The clients can be web application systems, native applications for a desktop computer, native applications for mobile computing devices, or any suitable client application instance (e.g., a client application instance of the external application client 170).

The media proxy service 110 preferably facilitates communicating a media stream between a least one client endpoint (e.g., 170) and at least a media server (e.g., 180) of the media service cluster 120. A media stream of a media session may further be routed through multiple media servers (e.g., media servers of the media server cluster 120), a communication application service (e.g., 140 of FIG. 1) (which can control state of a media session), and/or outside communication channels (e.g., external SIP services, PSTN, Over The Top (OTT) communication services, and the like). The media proxy service 110 is preferably a high performance proxy with operational capacity to handle tens of thousands of concurrent media sessions, but any suitable capacity may be used. The media proxy service 110 can be a SIP-based proxy such as OpenSIPS, a STUN/TURN server, or any suitable configured proxy. However, the media proxy service 110 may use any suitable signaling protocol. The media proxy service 110 can be configured to provide load balancing across the media server cluster 120. The media proxy service 110 may track the number of media sessions concurrently handled by media servers and, optionally, track the functional capabilities of the types of available media service. The media proxy service 110 may be configured to route newly routed media sessions to a media server node in the media server cluster 120 according to capacity and capabilities of the media server cluster 120. In alternative embodiments the media proxy service 110 can be an optional element.

The media server cluster 120 of a preferred embodiment functions to provide the media processing services. The media server cluster 120 is preferably a set of media servers (e.g., 180) that run on machines, virtual machines, containers, or other computing environments inside a distributed computing infrastructure. The media server cluster 120 may alternatively be hosted in any suitable manner. In one variation, there is one media server cluster 120 for the entire system. In another variation, there are multiple media server clusters 120 where each media server cluster 120 is located in a different geographically distinct region.

The media servers (e.g., 180) of the media server cluster 120 function to operate on the media stream—analyzing/processing the stream and/or augmenting the stream. In one preferred implementation, the media server cluster 120 includes a plurality of media servers that provide media transcoding services. Immutable media servers preferably inspect, analyze, log, and/or process media streams. A recording media service may be an example of an immutable media server. A mutable media server preferably alters, manipulates, and/or augments the communicated stream. The transcoding media can convert between media formats. As an example, a transcoding media server may convert between various codecs such as Speex used in mobile operating system applications (e.g., iOS and Android), Opus used in web and WebRTC applications, and PCMU used in PSTN and other media services. Any suitable codec or media transformation may alternatively be performed. The media server can additionally translate between media mediums such as converting a pure audio stream to a video stream or pulling the audio from a video into an audio stream. Other suitable media server services can include mixing, recording, translating, audio or video processing, answering machine detection, Text to Speech services, Interactive voice response services, DTMF detection, and/or any suitable media services.

The media servers (e.g., 180) can additionally include metering and logging layers that operate in coordination with the provided media services. The metering and logging function to create a record of notable activities. The metering can be used in providing programmatic hooks (e.g., callback URI triggering, application execution, and the like), billing/crediting an associated entity (e.g., charging for services or controlling resource access), creation of an audit trail, and/or other suitable functionality.

A media service API can be provided. The media service API can be a REST API. The API is preferably a RESTful API but may alternatively be any suitable API such as SOAP or custom protocol. The RESTful API works according to an application layer request and response model. An application layer request and response model may use HTTP, HTTPS SPDY, or any suitable application layer protocol. Herein HTTP may be used, but should be interpreted as being limited to the HTTP protocol. HTTP requests (or any suitable request communication) to the communication platform preferably observe the principles of a RESTful design. RESTful is understood in this document to describe a Representational State Transfer architecture as is known in the art. The RESTful HTTP requests are preferably stateless, thus each message communicated contains all necessary information for processing the request and generating a response. The API service can include various resources, which act as endpoints that can act as a mechanism for specifying requested information or requesting particular actions. The resources can be expressed as URI's or resource paths. The RESTful API resources can additionally be responsive to different types of HTTP methods such as GET, Put, POST and/or DELETE. The media service API can be used to provide information about current state of media sessions, events, media, or related data. The media service API can additionally provide interactive control of one or more operation of a media service.

The media server cluster 120 can be a substantially homogeneous cluster of identical or similar instances of the same media server. For example, a system may provide only one media focused process in which case all the media servers may be substantially similar. The media server cluster 120 may alternatively be heterogeneous containing more than one type of service provided by the media servers. In one example, there may be a first type of transcoding server operating on a first software (such as the FreeSWITCH) stack inside of the operating system of a virtual machine, and then a second type of transcoding server built to run in the virtual machine. In this example, the first type of media server may be a legacy media service, and the second type may be a new version of the media service. The use of the first and second type may be interchangeable. Alternatively, two of the media servers may not be interchangeable where each is designed for a particular purpose. For example, a subset of media servers may be for audio processing and a second subset of media servers for video processing operations. The media proxy service 110 can preferably dynamically route media streams appropriately.

A signaling controller 130 functions as a distinct service that manages signaling of a media stream. The signaling controller 130 preferably handles the signaling messaging that directs media streams. The signaling controller 130 preferably maintains state of the Session Description Protocol (SDP) mechanism of a communication session. A communication session preferably includes the media session and the directing signaling messages. The signaling controller 130 can preferably communicate SDP information to relevant resources such as an outside client initiating or receiving a communication, or to an internal resource such as a communication application service (e.g., 140).

The signaling controller 130 is preferably a service on a computing device distinct from that of the media resources (e.g., the media proxy service 110 and the media server cluster 120). The signaling controller 130 may be on a different host or optionally a different virtual machine. Operating independently, a communication session can be recovered during a failure of a media or signaling resource. In particular, if a host of a media resource, either a media proxy server or a media server, goes down, the associated signaling controller 130 for that communication session can re-establish the media session with a different media resource. Additionally, as distinct elements, the signaling controller 130 can perform asynchronous operations relating to a communication session. For example, a signaling controller 130 may asynchronously call out to an authentication service, and later act on an authentication response from the authentication service.

The signaling controller 130 can additionally include a set of orchestration services and state managers that function to manage the orchestration, allocation, and state of related services. The configuration of orchestration services and/or states managers may be different depending on the type and function of the provided media services. The orchestration service preferably includes application logic to interface and direct one or more media service state managers. The communication signaling is preferably managed within the signaling controller 130 (i.e., orchestration service). For example, incoming SIP communication is directed to the signaling controller 130, the orchestration service 130 then communicates with a media service state manager that sets up media service infrastructure to support the communication, the media service state manager then transmits the information back to the orchestration service which then negotiates the communication session as specified by the media service state manager. A media state manager can include application logic and state information to determine the state of a particular type of media communication session such as a conferencing media session, a transcoding media session, and the like. A media state manager may additionally include application logic to control the state of related media servers. There can be multiple types or media state managers, which apply different levels of media service modeling.

The system can additionally include a communication application service (e.g., 140), which functions to supply control logic to the communication session. The communication application service can be a combined media and signaling element, but may alternatively be split media and signaling system.

The system can additionally or alternatively include communication interfaces, which function to bridge media and/or signaling to outside communication channels such as the PSTN, SIP services, OTT media communication services, and/or any suitable communication channel.

The system may additionally include other components that function to support a media service as a platform offering. For example the system can include a queuing system to rate limit, prioritize, order, and manage shared usage of media servers and other resource. The system can additionally include a policy engine that functions to regulate apply policy to system activities of account, sub-account, ephemeral users, and/or other entities. The system can include an identity system that functions to create an authentication model and identity ecosystem within different system scopes (e.g., identity within an account or identity across multiple accounts). The presence system can additionally be included. In one variation, the functionality of the presence system is offered in a combined identity-presence system. A presence system can function to provide information about availability, device destination, and communication preferences. A routing service can be used to dynamically determine and select routes within the system. The system may additionally or alternatively include any suitable support sub-system.

The media service cluster 120 can include a variety of different specialized media services. Those media services may be combined into a monolithic media service, but the media services are preferably divided between more targeted media services such as transcoding services, recording services, text-to-speech services, speech recognition services, input detection services, conferencing services, and other suitable media services.

A transcoding service functions to convert between formats. The transcoding may convert an active media stream to another format. For example, a call with two endpoints may natively use two different codecs. The transcoding service may convert one or two of the legs of the communication to a common or compatible media stream format. Additionally, the transcoding service may work to convert accessed media resources that are or will be used in a communication session. For example, an MP3 file accessed from a URI may be converted to a wave file for playback during a phone call. In another example, a web client may use an OPUS codec while a mobile app may use Speex codec. The transcoding service preferably accepts a media stream in a first format and outputs a media stream in a second format.

A recording service preferably enables recording of calls or communication sessions. Recording is preferably for audio recording, but may additionally or alternatively include video recording, screen-sharing recording, multimedia recording, or any suitable recording service. The recording service may have additional features that may or may not be integrated into the recording service of the local service. Transcription is one preferred feature of the recording service. Transcription may use algorithmic speech recognition techniques, automated manual transcription, semi-automated techniques, and/or any suitable approach.

A Text-to speech service preferably generates, plays, and/or converts text into audible speech. The audible speech is then played within a communication stream. For example, a phone call may connect to a telephony application that specifies a script that should be read to the caller. The script is preferably directed to the TTS service to be played during the phone call. The text-to-speech services are preferably for audio communication. However, a computer generated video simulation or rendering of a speaker may additionally be created for video communication. The text-to-speech service preferably takes text as an input and outputs an audio stream that can be played or mixed in with the communication session

A speech recognition service is preferably a service used in collecting spoken input and converting it into a format for transcription, natural language processing, or interpretation of responses. The speech recognition may use the transcription component described above, but may alternatively use an alternative approach. The input to the speech recognition is preferably an audio stream and parameters of speech recognition.

An input detection service functions to gather inputs of a communication device. Preferably the input detection service collects DTMF inputs from a user. In the DTMF input detection variation, an audio stream and parameters of detection are preferably an input to the service. The components of an answering machine detection service may alternatively be integrated into the input detection service or any suitable service.

Conferencing services preferably facilitate calls with more than two endpoints connected. Various features of conference calls may be enabled through components of conferencing services. The conferencing service preferably mixes audio for audio and/or video sessions.

### 2. Method for Managing Media and Signaling

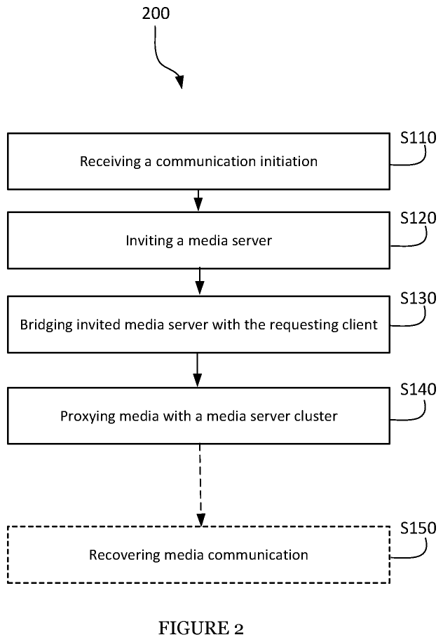

As shown in FIG. 2, a method (e.g., 200) for managing media and signaling in a communication platform can include receiving a communication initiation S110, inviting a media server (e.g., the media server 180 of FIG. 1) S120, bridging the invited media server with the requesting client (e.g., the client 170 of FIG. 1) S130, and proxying media with a media server cluster (e.g., the media server 180 of the media server cluster 120) S140. The method functions to establish a media stream through media resources that are separate from the signaling resources. Additionally, the method can be applied to enable: scaling media resources independent from signaling resources; recovering a communication stream when a media resource fails; and providing a variety of media services.

Block S110, which includes receiving a communication initiation, functions to receive an invite from a client service (e.g., 170). Preferably, a signaling and media communication protocol is used in interfacing with external client devices such as communication endpoints, applications, or other external communication systems. More preferably, the protocol substantially conforms to the session initiation protocol (SIP), but any suitable protocol may be used. Alternatively, other communication approaches such as WebRTC, which may have a control channel and a media, real-time communication channel may alternatively or additionally be supported. Herein, SIP is used as the exemplary protocol, but it would be appreciated by one skilled in the art that alternative protocol communication may be used. The communication initiation preferably occurs as a result of an INVITE. In response, ‘100’ Trying response can be returned. The INVITE is preferably received from an external client (e.g., 170), and is received at a signaling controller (e.g., 130). As described above, the signaling controller (e.g., 130) preferably manages the control directives that orchestrate the communication (e.g., the non media communication). The external client (e.g., 170) is preferably a system operated by an account holder of the platform.

The communication initiation preferably initiates a set of asynchronous events within a signaling controller (e.g., 130). The asynchronous events can be passed off to any suitable number of handlers. The handler services can determine how the communication initiation is handled. In one variation, pluggable authentication services can be integrated into the communication process during the asynchronous events. The type of authentication can depend on particular situations such as the type of communication, the type of client device, and other suitable conditions.

Block S120, which includes inviting media server (e.g., 180), functions to dispatch the communication initiation to media related systems. Dispatchers can be services that distribute a communication initiation to a media service. A session description protocol (SDP) message or any suitable communication descriptor is transparently passed to the media services. The media services (e.g., the media proxy service 110, the media server 180) are preferably distinct from the signaling controller (e.g., 130). A smart media control function may sit in front of a media server cluster (e.g., 120). The media control function can provide basic traffic forwarding to media services, but may additionally provide smart load balancing. The capacity of media servers can be monitored and traffic routed to different media instances according to the capacity.

Block S130, which includes bridging invited media server (e.g., 180) with a requesting client (e.g., 170), functions to connect the media communication of the client with that of the media server. Preferably, the media server system (e.g., 180) will issue an INVITE back to the signaling controller (e.g., 130). The INVITE from the media server is preferably correlated with the initial INVITE sent to the media server. In response, the session description information (e.g., the SDP received from the media server), is used to INVITE the media proxy (e.g., the media proxy service 110) and establish a back-to-back user agent from the original INVITE from the client—control signaling is executed to establish the media proxy (e.g., 110) in the media communication flow between the client (e.g., 170) and the media server cluster (e.g., 120). The media proxy (e.g., 110) preferably exists as an edge node of the communication platform. The media proxy will preferably have standard EIPs such that a client can whitelist and/or prioritize real time protocol traffic between the client and the media proxy. With a standardized IP address of the media proxy, a client system (e.g., 170) can rely on a consistent set of components with which they will interface.

Block S140, which includes proxying media with the media server cluster (e.g., the media server 180 of the cluster 120), functions to communicate media between the client and the media server cluster. Preferably a media proxy (e.g., 110) is established as an intermediary component between the client and at least the used media services in the media server cluster. The media proxy can preferably support numerous concurrent media channels. As one example, tens of thousands of media sessions can be proxied by a proxying media server. The media proxy servers can additionally be scaled to support more concurrent media sessions. The media proxy could be a SIP-based proxy but may alternatively be a TURN server, or any suitable proxying system.

During, the communication, the signaling controller (e.g., 130) can preferably augment and modify the media services. Media services may receive new instructions; media services can be added to the media route; media services can be removed from the media route; and other suitable actions can be directed from the signaling controller. If the media requirements change, then the signaling controller

Additionally the method can include recovering from a media service failure. The signaling controller or any suitable signaling resource can preferably re-establish media communication in the event of a media communication failure. For example, if a media server in the cluster fails, the signaling controller can re-negotiate a new media channel.

Similarly, the method may include recovering from a signaling service failure. In some cases signaling may involve multiple components, which can provide some redundancy in the state of the communication session. Since the media channel is distinct from the signaling channel, if a signaling component fails, the system can re-establish new signaling resources while maintaining the media channel. This may involve augmenting the media resources as well.

In one preferred variation, the signaling and media communication is used to support a communication application session. The method can be used to establish a media channel that substantially flows from the client device (e.g., 170), to a media proxy server (e.g., 110), to the used media server instances (e.g., 180) and then to a communication application service (e.g., 140) (such as a call router which can process application instructions). The media channel may terminate within the communication platform, such as when a media player service is generating media for a connected endpoint. Alternatively, the media channel may be further connect out to a provider gateway (e.g., 150 of FIG. 1) to some external communication system (e.g., 160 of FIG. 1) such as a PSTN carrier network, a SIP network, an over-the-top communication platform, or any suitable external communication system. A signaling controller (e.g., 130) preferably maintains the signaling channel with some access to the involved media resources and the communication application service.

In one variation, the method and system can be applied to a media service platform. The method is preferably operated to facilitate providing media access and use to outside applications and services as a form of service. Outside entities can delegate media processing tasks, which otherwise may require considerable technical investment for the outside entities to develop and/or maintain. As a media service provider, the system and method can provide transcoding services, conferencing services, DTMF tone interpretations, scaling of picture in a video stream, or any suitable media service. The media services can originate through one service and be terminated in any suitable destination endpoint, but the media streams may alternatively originate and terminate in the same external service.

Additionally, the system and method can provide a dynamic architecture that can be scaled to meet demand and can be distributed across geographically distinct regions.

### 3. Communication Platform System and Media System

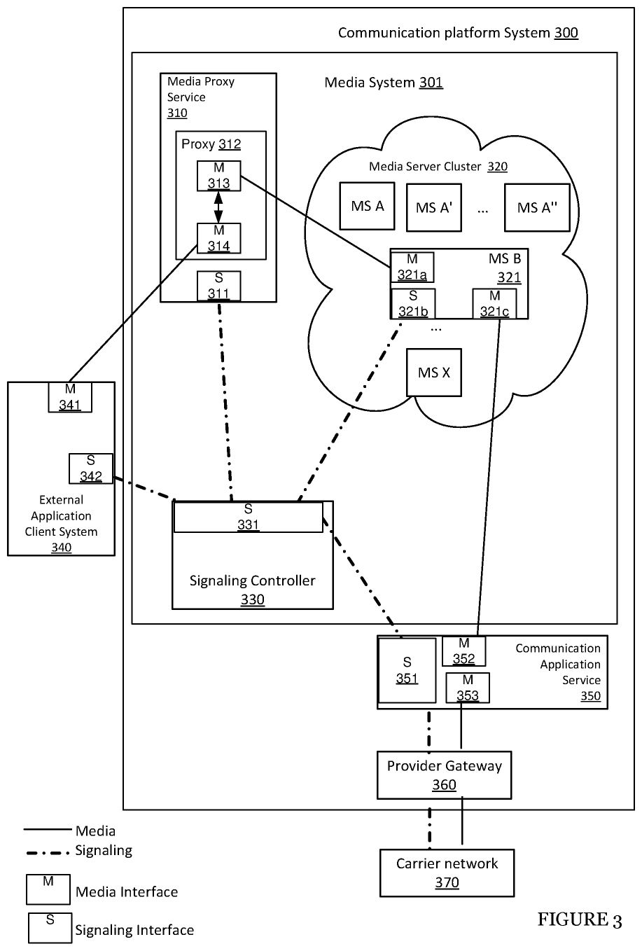

As shown in FIG. 3, a communication platform system 300, in accordance with an embodiment, includes a media system 301, a communication application service 350 and a provider gateway 360.

In some implementations, the communication application service 350 is similar to the communication application service 140 of FIG. 1. In some implementations, the provider gateway 360 is similar to the provider gateway 150 of FIG. 1. In some implementations, the carrier network 370 is similar to the carrier network 160 of FIG. 1. In some implementations, the external application client system 340 is similar to the external application client system 170 of FIG. 1.

The media system 301 includes a media proxy service 310, a media server cluster 320, and a signaling controller 330. In some implementations, the media proxy service 310 includes at least one media proxy (e.g., the media proxy 312).

In some implementations, the media proxy (e.g., 312) includes a back-to-back user agent. In some implementations, the media proxy service 310 includes at least one of a SIP-based proxy, and a STUN (Session Traversal Utilities for NAT (Network Address Translator))/TURN (Traversal Using Relays around NAT) server. In some implementations, the SIP-based proxy includes an OpenSIPS proxy.

In some implementations, the media server cluster 320 includes at least one media server (e.g., the media server 321).

In some implementations, the media proxy service 310 is similar to the media proxy service 110 of FIG. 1. In some implementations, the media server cluster 320 is similar to the media server cluster 120 of FIG. 1. In some implementations, the signaling controller 330 is similar to the signaling controller 130 of FIG. 1.

In some implementations, the provider gateway 360 is communicatively coupled to a carrier network 370 and the communication application service 350. In some implementations, the media system 301 is communicatively coupled to an external application client system 340 and the communication application service 350. In some implementations, the media system is external to the communication platform system 300. In some implementations, the media system is external to the communication platform system 300, and the media system is communicatively coupled to an external application client system (e.g., 340).

### 3.1 Signaling Interfaces and Media Interfaces

In some implementations, the external application client system 340 includes a media interface 341 and a signaling interface 342. In some implementations, the signaling controller includes a signaling interface 331. In some implementations, the media server 321 includes the media interface 321a, and a signaling interface 321b. In some implementations, the media server 321 includes media interfaces 321a and 321c, and a signaling interface 321b. In some implementations, the media proxy service includes a signaling interface 311. In some implementations, the media proxy 312 includes a client proxy media interface 314 and a media server proxy media interface 313. In some implementations, the communication application service 350 includes a signaling interface 351 and a media interface 352. In some implementations, the communication application service 350 includes a signaling interface 351 and the media interfaces 352 and 353.

In some implementations, each media interface (e.g., 313, 314, 321a, 321c, 341, 352, and 354), corresponds to at least one of a media communication IP address, a media communication port, a media communication protocol, and a media processing codec. In some implementations, the media communication protocol is RTP (Real-time Transport Protocol). In some implementations, each signaling interface (e.g., 311, 321b, 331, 342, and 351), corresponds to at least one of a signaling IP address, a signaling communication port, and a signaling protocol.

### 3.2 Communication of Signaling Messages

In some implementations, the client system 340 and the signaling controller 330 communicate signaling messages by using the signaling interface 342 and the signaling interface 331, respectively. In some implementations, the client system 340 provides the signaling controller 330 with at least a first communication initiation from the signaling interface 342 (of the client system) to the signaling interface 331 (of the signaling controller).

In some implementations, the signaling controller 330 and the media server 321 communicate signaling messages by using the signaling interface 331 and the signaling interface 321b, respectively.

In some implementations, the signaling controller 330 and the media proxy service 310 communicate signaling messages by using the signaling interface 331 and the signaling interface 311, respectively.

In some implementations, the signaling controller 330 and the communication application service 350 communicate signaling messages by using the signaling interface 331 and the signaling interface 351, respectively.

In some implementations, the communication application service 350 and the provider gateway 360 communicate signaling messages by using the signaling interface 351 of the communication application service 350.

### 3.3 Media Communication

In some implementations, the media proxy service 110 and the media server 321 communicate media by using the media interface 313 and the media interface 321a, respectively.

In some implementations, the media proxy service 110 and the client system 340 communicate media by using the media interface 314 and the media interface 341, respectively.

In some implementations, the media server 321 and the communication application service 350 communicate media by using the media interface 321c and the media interface 352, respectively.

In some implementations, the communication application service 350 and the provider gateway 360 communicate media by using the media interface 354 of the communication application service 350.

In some implementations, media is communicated by using a Real-time Transport Protocol (RTP).

### 3.4 Computing Devices

In some implementations, the communication platform system 301 is implemented as a single server device. In some implementations, the communication platform system 301 is implemented as a distributed computing system that includes a plurality of server devices, and each server device of the distributed computing system includes one or more of the media system 301, the communication application service 350, and the provider gateway 360.

In some implementations, the media system 301 is implemented as a single server device. In some implementations, the media system 301 is implemented as a distributed computing system that includes a plurality of server devices, and each server device of the distributed computing system includes one or more of the media proxy service 310, the media server cluster 320, and the signaling controller 330.

In some implementations, the media proxy service 310 is implemented as a single server device. In some implementations, the media proxy service 310 is implemented as a distributed computing system that includes a plurality of server devices.

In some implementations, the media server 321 is implemented as a single server device. In some implementations, the media server 321 is implemented as a distributed computing system that includes a plurality of server devices.

In some implementations, the media server cluster 320 is implemented as a single server device. In some implementations, the media server cluster 320 is implemented as a distributed computing system that includes a plurality of server devices.

In some implementations, the signaling controller 330 is implemented as a single server device. In some implementations, the signaling controller 330 is implemented as a distributed computing system that includes a plurality of server devices.

In some implementations, the communication application service 350 is implemented as a single server device. In some implementations, the communication application service 350 is implemented as a distributed computing system that includes a plurality of server devices.

In some implementations, the provider gateway 360 is implemented as a single server device. In some implementations, the provider gateway 360 is implemented as a distributed computing system that includes a plurality of server devices.

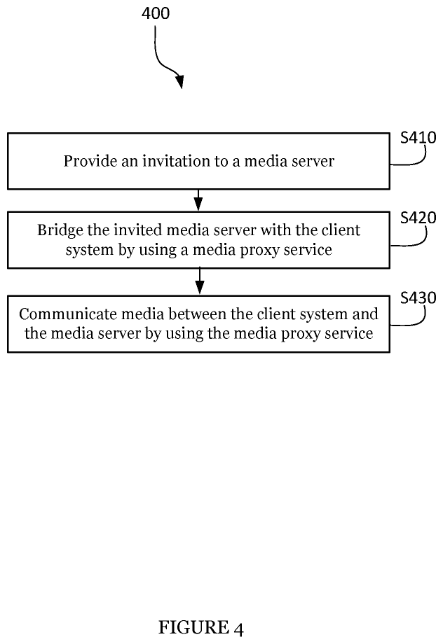

### 4. Method of FIG. 4

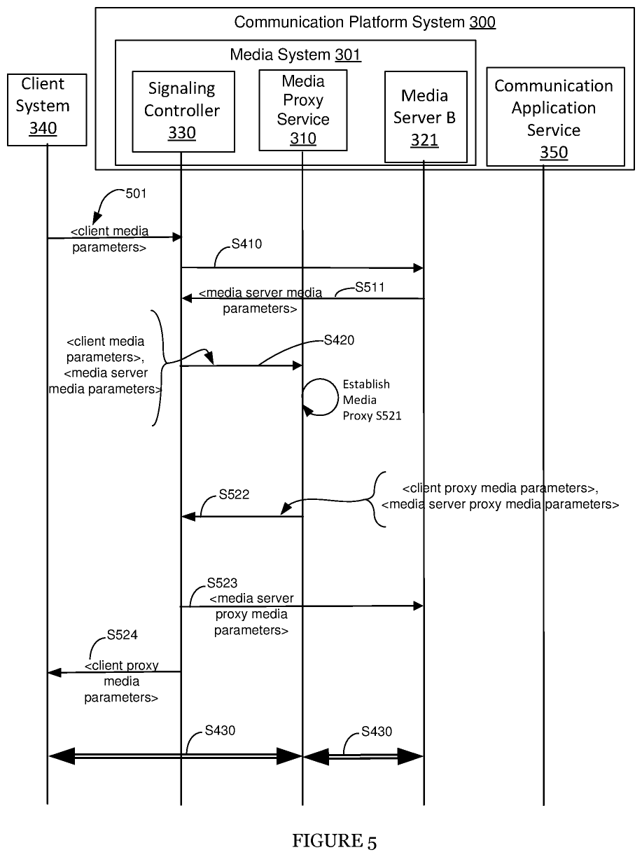

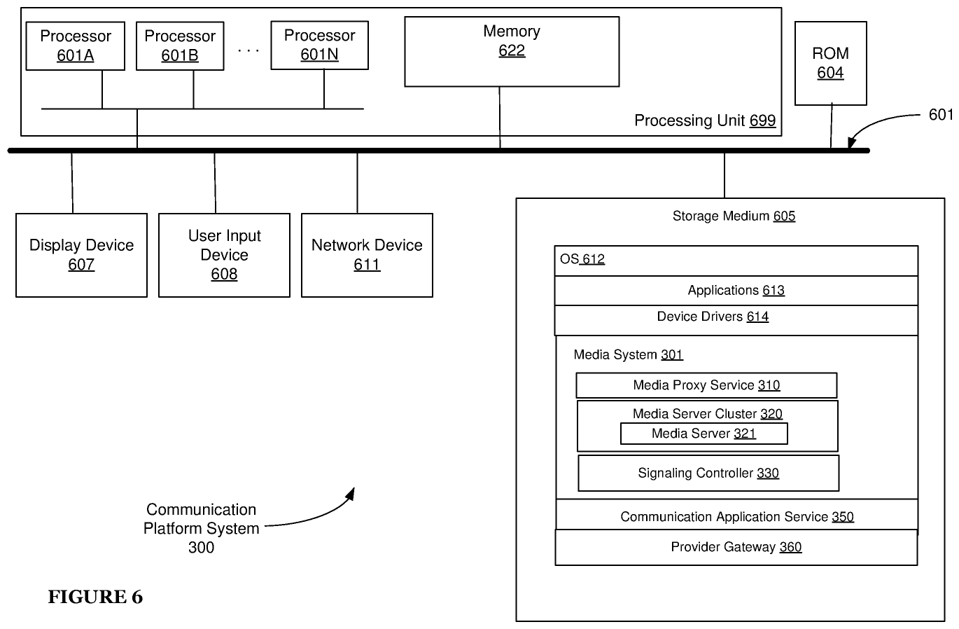

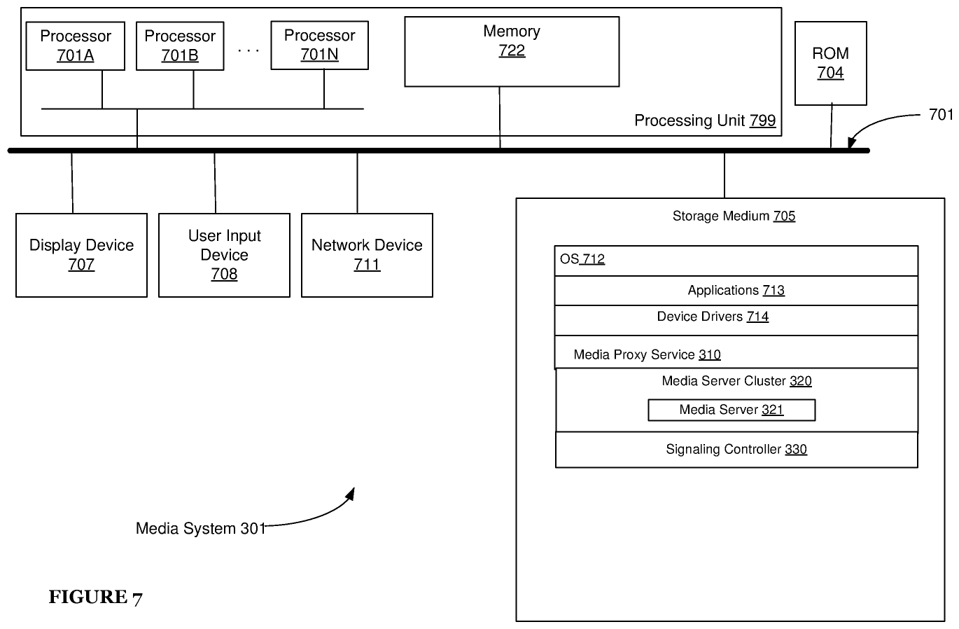

FIG. 4 is a process block diagram of a method 400 of an embodiment, and FIG. 5 is a communication sequence diagram of an implementation of the method 400. The method 400 of FIGS. 4 and 5 is performed at a communication platform system (e.g., 300 of FIGS. 3 and 6), and responsive to a first communication initiation (e.g., 501 of FIG. 5) received by the signaling controller (e.g., 330 of FIG. 3) of the communication platform system (e.g., 300) from a client system (e.g., 340) external to the communication platform system. In some embodiments, the method 400 is performed at a media system (e.g., 301 of FIGS. 3 and 7).

The method 400 includes: providing an invitation to a media server (e.g., 321 of FIG. 3) of the communication platform system (e.g., 300) based on the first communication initiation (e.g., 501 of FIG. 5), the first communication initiation specifying client media parameters, the invitation being provided by the signaling controller (e.g., 330) (process S410); bridging the invited media server (e.g., 321) with the external client system (e.g., 340) by using a media proxy service (e.g., 310) of the communication platform system (process S420); and communicating media between the external client system (e.g., 340) and the invited media server (e.g., 321) by using the media proxy service (e.g., 310) (process S430).

Process S420, which includes bridging the invited media server with the external client system by using the media proxy service, includes: responsive to a first signaling message provided by the invited media server (e.g., the signaling message of the process S511 of FIG. 5), the signaling controller providing an invitation to the media proxy service (e.g., the signaling message of the process S420 shown in FIG. 5) to establish media communication (processes S521, S522, S523, S524) with the external client system based on the first signaling message, the media server providing the first signaling message (e.g., the signaling message of the process S511) responsive to the invitation (e.g., the signaling message of the process S410 shown in FIG. 5) provided by the signaling controller.

In some implementations, the signaling controller 330 performs the process S410. In some implementations, the signaling controller 330 performs the process S420. In some implementations, the media proxy service 310 performs the process S430. In some implementations, the media server (e.g., 321) performs the process S511. In some implementations, the media proxy service 310 performs the process S521. In some implementations, the media proxy service 310 performs the process S522. In some implementations, the signaling controller 330 performs the process S523. In some implementations, the signaling controller 330 performs the process S524.

In some implementations, the process S410 is similar to the process S120 of FIG. 1. In some implementations, the process S420 is similar to the process S130 of FIG. 1. In some implementations, the process S430 is similar to the process S140 of FIG. 1.

In some implementations, the first communication is received by the signaling controller as described above for S110 of FIG. 2.

In some implementations, the method 400 includes recovering media communication by using the signaling controller. In some implementations, the media communication is recovered as described above for S150 of FIG. 2.

### 4.1 Providing an Invitation to a Media Server

In some implementations, the process S410 functions to control the signaling controller 330 to invite a media server (e.g., 321) of the media system 301 by providing an invitation to the media server. In some implementations, the invitation is provided based on the first communication initiation (e.g., 501). The first communication initiation specifies client media parameters. In some implementations, the client media parameters identify the client system media interface 341. In some implementations, the client media parameters include at least media communication information of the client system (e.g., 340). In some implementations, media communication information of the client system includes at least one of a media communication IP address of the client system, a media communication port of the client system, a media communication protocol of the client system, and a media processing codec of the client system.

In some implementations, the signaling controller 330 provides the invitation to the media server via a signaling message (e.g., the signaling message of the process S410 shown in FIG. 5). In some implementations, the signaling controller 330 provides the invitation to the media server via a SIP message. In some implementations, the invitation is a SIP INVITE request, and invitation includes the client media parameters as session description protocol (SDP) parameters of the SIP INVITE request.

In some implementations, the first communication initiation (e.g., 501) is a SIP INVITE request. In some implementations, the first communication initiation is a SIP INVITE request, and the client media parameters are session description protocol (SDP) parameters of the SIP INVITE request.

In some implementations, the signaling controller 330 receives the first communication initiation (e.g., 501) via the signaling interface 331 of the signaling controller 330, and the client system (e.g., 340) provides the first communication initiation via a signaling interface (e.g., 342) of the client system.

In some implementations, the signaling controller 330 provides the invitation via the signaling interface 331, and the media server receives the invitation via a signaling interface (e.g., 321b).

In some implementations, providing an invitation to a media server includes selecting at least one of a plurality of media servers. In some implementations, the signaling controller 330 selects a media server of the cluster 320 by using at least one of a media state manager (e.g., the media state manager described above for FIG. 1), a dispatcher (e.g., the dispatcher described above for S120 of FIG. 2), and a smart media control function (e.g., the smart media control function described above for S120 of FIG. 2).

In some implementations, the media server (e.g., 321) is included in the media server cluster 320, and providing an invitation to a media server (e.g., 321) includes controlling the signaling controller 330 to provide the invitation to the media server (e.g., 321) by using a media server cluster controller of the media system 301.

### 4.2 Bridging the Invited Media Server

In some implementations, the process S420 functions to bridge the invited media server (e.g., 321) with the external client system (e.g., 340) by using the media proxy service 310 of the media system 301.

In some implementations, the signaling controller 330 provides media server media parameters of a signaling message provided by the media server (e.g., the signaling message of the process S511) and the client media parameters of the first communication initiation (e.g., 501) to the media proxy service 310 via at least a second signaling message (e.g., the signaling message of the process S420 shown in FIG. 5). In some implementations, the signaling controller 330 controls the media proxy service 310 to establish a media proxy (e.g., 312) by providing the client media parameters and the media server media parameters to the media proxy service 310 via at least one signaling message (e.g., the signaling message of the process S420 shown in FIG. 5).

In some implementations, the media proxy service 310 establishes media communication with the external client system by using the client media parameters, and establishes media communication with the media server by using the media server media parameters. In some implementations, the first communication initiation (e.g., 501), the invitation (e.g., the signaling message of the process S410 shown in FIG. 5) the first signaling message (e.g., the signaling message of the process S511), and the second signaling message (e.g., the signaling message of the process S420 shown in FIG. 5) are Session Initiation Protocol (SIP) INVITE requests.

In some implementations, the client media parameters are included in the first communication initiation (e.g., 501) as session description protocol (SDP) parameters. In some implementations, the client media parameters are included in the invitation (e.g., the signaling message of the process S410 shown in FIG. 5) as SDP parameters. In some implementations, the media server media parameters are included in the first signaling message (e.g., the signaling message of the process S511) as SDP parameters. In some implementations, the client media parameters and the media server media parameters are included in the second signaling message (e.g., the signaling message of the process S420 shown in FIG. 5) as SDP parameters.

In some implementations, the first signaling message (e.g., the signaling message of the process S511) is a SIP response (e.g., “200 OK”), and the media server media parameters are included in the first signaling message as SDP parameters.

In some implementations, the first signaling message (e.g., the signaling message of process S511) identifies the media proxy service (e.g., 310).

In some implementations, the media server (e.g., 321) provides the first signaling message (e.g., the signaling message of process S511) via the signaling interface 321b, and the signaling controller 330 receives the signaling message via the signaling interface 331.

In some implementations, the signaling controller 330 provides the second signaling message (e.g., the signaling message of the process S420 shown in FIG. 5) via the signaling interface 331, and the media proxy service 310 receives the signaling message via the signaling interface 311.

In some implementations, bridging the invited media server includes controlling the media proxy service 310 of the media system 301 to establish a media proxy (e.g., 312) (process S521) between the client system (e.g., 340) and the media server (e.g., 321) by using the client media parameters of the first communication initiation (e.g., 501) and media server media parameters provided by the media server (e.g., 321) responsive to the invitation (e.g., the media server media parameters provided at the process S511).

In some implementations, the media server media parameters identify the media server media interface (e.g., 321a). In some implementations, the media server media parameters include at least media communication information of the media server (e.g., 321). In some implementations, media communication information of the media server includes at least one of a media communication IP address of the media server, a media communication port of the media server, a media communication protocol of the media server, and a media processing codec of the media server.

### 4.2.1 Providing Proxy Parameters to the Client System and the Media Server

In some implementations, establishing a media proxy between the client system and the media server includes: providing client proxy parameters to the client system (e.g., 340) (process 524 of FIG. 5); and providing media server proxy parameters to the media server (e.g., 321) (process 523 of FIG. 5). In some implementations, the media server proxy parameters identify the media proxy media interface 313. In some implementations, the client proxy parameters identify the client proxy media interface 314.

In some implementations, the media server proxy parameters include at least media communication information of the media proxy media interface 313. In some implementations, media communication information of the media proxy media interface 313 includes at least one of a media communication IP address of the media proxy media interface 313, a media communication port of the media proxy media interface 313, a media communication protocol of the media proxy media interface 313, and a media processing codec of the media proxy media interface 313.

In some implementations, the client proxy parameters include at least media communication information of the client proxy media interface 314. In some implementations, media communication information of the client proxy media interface 314 includes at least one of a media communication IP address of the client proxy media interface 314, a media communication port of the client proxy media interface 314, a media communication protocol of the client proxy media interface 314, and a media processing codec of the client proxy media interface 314.

In some implementations, the media proxy service 310 provides the client proxy parameters and the media proxy parameters to the signaling controller 330 via at least one signaling message (e.g., the signaling message of the process S522). In some implementations, the media proxy service 310 provides the signaling message (e.g., the signaling message of the process S522) via the signaling interface 311, and the signaling controller 330 receives the signaling message via the signaling interface 331.

In some implementations, the signaling message of the process S522 is a SIP message. In some implementations, the signaling message of the process S522 is a SIP response (e.g., “200 OK”) to the signaling message of the process S420 (shown in FIG. 5). In some implementations, the client proxy parameters and the media proxy parameters are included in the signaling message of the process S522 as SDP parameters.

In some implementations, the signaling controller 330 provides the client proxy parameters to the client system (e.g., 340) via a signaling message (e.g., the signaling message of the process S524), and the signaling controller 330 provides the media server proxy parameters to the media server (e.g., 321) via a signaling message (e.g., the signaling message of the process S523).

In some implementations, the signaling controller 330 provides the signaling message of the process S523 via the signaling interface 331, and the media server 321 receives the signaling message via the signaling interface 321b. In some implementations, the signaling message of the process S523 is a SIP message. In some implementations, the signaling message of the process S523 is a SIP response (e.g., “200 OK”) to the signaling message of the process S511. In some implementations, the media server proxy parameters are included in the signaling message of the process S523 as SDP parameters.

In some implementations, the signaling controller 330 provides the signaling message of the process S524 via the signaling interface 331, and the client system 340 receives the signaling message via the signaling interface 342. In some implementations, the signaling message of the process S524 is a SIP message. In some implementations, the signaling message of the process S524 is a SIP response (e.g., “200 OK”) to the first communication initiation 501. In some implementations, the client proxy parameters are included in the signaling message of the process S524 as SDP parameters.

### 4.3 Communicating Media by Using the Media Proxy Service

In some implementations, the process S430 functions to communicate media between the external client system (e.g., 340) and the invited media server (e.g., 321) by using the established media proxy (e.g., the media proxy 312 of the media proxy service 310) (e.g., the media proxy established at the process S521 of FIG. 5).

In some implementations, communicating media between the external client system (e.g., 340) and the invited media server (e.g., 321) by using the established media proxy (e.g., 312) includes controlling the media proxy service 310 to provide media received from the client system to the media server by using the media server media parameters (e.g., the media server media parameters of the process s511), and the client system provides the media to the media proxy service 310 by using the client proxy parameters (e.g., the client proxy parameters of the process S524).

In some implementations, communicating media between the external client system (e.g., 340) and the invited media server (e.g., 321) by using the established media proxy (e.g., 312) includes controlling the media proxy service 310 to provide media received from the media server to the client system by using the client media parameters (e.g., the client media parameters of the communication initiation 501), and the media server provides the media to the media proxy service 310 by using the media server proxy parameters (e.g., the media proxy parameters of the process S523).

In some implementations, the media proxy service 310 uses the media interface 313 to provide media received at the media interface 314 to the media server via the media interface 321a. In some implementations, the media proxy service 310 uses the media interface 314 to provide media received at the media interface 313 to the client system via the media interface 341.

### 4.4 Controlling Media Communication

In some implementations, the method 400 includes controlling media communication responsive to a signaling message provided by at least one of the client system (e.g., 340), the media server (e.g., 321) and the media proxy service 310. In some implementations, the signaling controller 330 receives the signaling message to control media communication (via the signaling interface 331). In some implementations, responsive to the signaling message to control media communication, the signaling controller 330 provides at least one signaling message to at least one of the client system (e.g., 340), the media server (e.g., 321) and the media proxy service 310.

In some implementations, controlling media communication includes at least one of ending media communication, recovering media communication, controlling operations performed on the media, controlling transcoding of the media, controlling a recording service, controlling a text-to-speech service, controlling a speech recognition service, controlling an input detection service, controlling a conferencing service, controlling a communicating application service (e.g., 350), and the like.

In some implementations, the method 400 includes ending media communication responsive to a signaling message (e.g., a SIP BYE message) provided by at least one of the client system (e.g., 340), the media server (e.g., 321) and the media proxy service 310. In some implementations, the signaling controller 330 receives the signaling message to end media communication (e.g., a SIP BYE message) (via the signaling interface 331). In some implementations, responsive to the signaling message to end media communication, the signaling controller 330 provides at least one signaling message to at least one of the client system (e.g., 340), the media server (e.g., 321) and the media proxy service 310.

### 5. Communication Application Service

In some implementations, the communication platform system 300 provides signaling and media communication to support a communication application session (e.g., of the communication application service 350), and the signaling controller 330 establishes a signaling channel with the communication application service 350 of the communication platform system 300. In some implementations, the signaling controller 330 establishes the signaling channel between the singling interface 331 of the signaling controller and the signaling interface 351 of the communication application service 350.

In some implementations, the communication application service 350 establishes a signaling channel and media communication with the provider gateway 360 of the communication platform system. In some implementations, the communication application service 350 establishes the signaling channel between the signaling interface 351 of the communication application service 350 and the provider gateway 360. In some implementations, the communication application service 350 establishes the media communication between the media interface 354 of the communication application service 350 and the provider gateway 360.

In some implementations, the communication application service 350 communicates media between the media interface 354 of the communication application service 350 and the media interface of a media server (e.g., the media interface 321c of the media server 321).

In some implementations, the communication application service 350 includes a call router (e.g., a call router as described above for FIG. 2).

### 6. Media Service Platform

In some implementations, the communication platform system is a media service platform (e.g., a platform that includes a media system similar to the media system 301), and the media services provided by the media service platform include at least one of transcoding services, conferencing services, DTMF tone interpretations, and scaling of picture in a video stream.

### 7. System Architecture: Communication Platform System

FIG. 6 is an architecture diagram of a system (e.g., the communication platform system 300 of FIG. 3) according to an implementation in which the system is implemented by a server device. In some implementations, the system is implemented by a plurality of devices. In some implementations, the system 300 is similar to the system of FIG. 1.

The bus 601 interfaces with the processors 601A-601N, the main memory (e.g., a random access memory (RAM)) 622, a read only memory (ROM) 604, a processor-readable storage medium 605, a display device 607, a user input device 608, and a network device 611.

The processors 601A-601N may take many forms, such as ARM processors, X86 processors, and the like.

In some implementations, the system (e.g., 300) includes at least one of a central processing unit (processor) and a multi-processor unit (MPU).

The processors 601A-601N and the main memory 622 form a processing unit 699. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of a media system, a communication application service, and a provider gateway.

The network adapter device 611 provides one or more wired or wireless interfaces for exchanging data and commands between the system (e.g., 300) and other devices, such as a client system 340 and a carrier network 370. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory 622 (of the processing unit 699) from the processor-readable storage medium 605, the ROM 604 or any other storage location. During execution of these software programs, the respective machine-executable instructions are accessed by at least one of processors 601A-601N (of the processing unit 699) via the bus 601, and then executed by at least one of processors 601A-601N. Data used by the software programs are also stored in the memory 622, and such data is accessed by at least one of processors 601A-601N during execution of the machine-executable instructions of the software programs. The processor-readable storage medium 605 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 605 includes machine-executable instructions (and related data) for an operating system 612, software programs 613, device drivers 614, the media system 301, the communication application service 350, and the provider gateway 360. As shown in FIG. 6, the machine-executable instructions (and related data) for the media system 301 include machine-executable instructions (and related data) for the media proxy service 310, the media server cluster 320, the signaling controller 330, and the media server 321.

### 8. System Architecture: Media System

FIG. 7 is an architecture diagram of a media system (e.g., the media system 301 of FIG. 3) according to an implementation in which the media system is implemented by a server device. In some implementations, the system is implemented by a plurality of devices.

The bus 701 interfaces with the processors 701A-701N, the main memory (e.g., a random access memory (RAM)) 722, a read only memory (ROM) 704, a processor-readable storage medium 705, a display device 707, a user input device 708, and a network device 711.

The processors 701A-701N may take many forms, such as ARM processors, X86 processors, and the like.

In some implementations, the media system (e.g., 301) includes at least one of a central processing unit (processor) and a multi-processor unit (MPU).

The processors 701A-701N and the main memory 722 form a processing unit 799. In some embodiments, the processing unit includes one or more processors communicatively coupled to one or more of a RAM, ROM, and machine-readable storage medium; the one or more processors of the processing unit receive instructions stored by the one or more of a RAM, ROM, and machine-readable storage medium via a bus; and the one or more processors execute the received instructions. In some embodiments, the processing unit is an ASIC (Application-Specific Integrated Circuit). In some embodiments, the processing unit is a SoC (System-on-Chip). In some embodiments, the processing unit includes one or more of a media proxy service, a media server cluster, a signaling controller, and a media server.

The network adapter device 711 provides one or more wired or wireless interfaces for exchanging data and commands between the media system (e.g., 301) and other devices, such as a client system (e.g., 340) and a communication application service (e.g., 350) of a communication platform system. Such wired and wireless interfaces include, for example, a universal serial bus (USB) interface, Bluetooth interface, Wi-Fi interface, Ethernet interface, near field communication (NFC) interface, and the like.

Machine-executable instructions in software programs (such as an operating system, application programs, and device drivers) are loaded into the memory 722 (of the processing unit 799) from the processor-readable storage medium 705, the ROM 704 or any other storage location. During execution of these software programs, the respective machine-executable instructions are accessed by at least one of processors 701A-701N (of the processing unit 799) via the bus 701, and then executed by at least one of processors 701A-701N. Data used by the software programs are also stored in the memory 722, and such data is accessed by at least one of processors 701A-701N during execution of the machine-executable instructions of the software programs. The processor-readable storage medium 705 is one of (or a combination of two or more of) a hard drive, a flash drive, a DVD, a CD, an optical disk, a floppy disk, a flash storage, a solid state drive, a ROM, an EEPROM, an electronic circuit, a semiconductor memory device, and the like. The processor-readable storage medium 705 includes machine-executable instructions (and related data) for an operating system 712, software programs 713, device drivers 714, the media proxy service 310, the media server cluster 320, the signaling controller 330, and the media server 321.

### 9. Machines

The system and methods of the preferred embodiment and variations thereof can be embodied and/or implemented at least in part as a machine configured to receive a computer-readable medium storing computer-readable instructions. The instructions are preferably executed by computer-executable components preferably integrated with the media and signaling components of a communication platform or a media system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

### 10. Conclusion

As a person skilled in the art will recognize from the previous detailed description and from the figures and claims, modifications and changes can be made to the preferred embodiments of the invention without departing from the scope of this invention defined in the following claims.

1. A method comprising:
receiving a communication initiation from a client system;
selecting a media server based on the communication initiation;
identifying a client codec associated with the client system;
identifying a media server codec for the media server in response to identifying the client codec; and
bridging the media server and the client system with a proxy service based on the client codec and the media server codec, the proxy service being established to facilitate media communication between the client system and the media server.

2. The method of claim 1, wherein the communication initiation is received by a signaling controller that manages signaling messaging that directs media streams.

3. The method of claim 2, comprising:
providing, by the signaling controller, a media server proxy parameter to the media server, the providing of the media server proxy parameter including sending a first message via a signaling interface of the signaling controller to the media server; and
providing, by the signaling controller, a client proxy parameter to the client system, the providing of the client proxy parameter including sending a second message from the signaling interface of the signaling controller to the client system.

4. The method of claim 3, comprising:
identifying a media server interface of the proxy service based on the media server proxy parameter; and
identifying a media client interface of the proxy service based on the client proxy parameter.

5. The method of claim 3, wherein the proxy service communicates media with the client system using the client codec and client interface codec, and wherein the proxy service communicates media with the media server using the media server codec and media server interface codec.

6. The method of claim 3, wherein the first message comprises a signaling message using a signaling resource separate from a media resource used for media communication.

7. The method of claim 4, wherein the media client interface is usable by the client system for communicating media between the proxy service and the client system, and wherein the media server interface is usable by the media server for communicating media between the proxy service and the media server.

8. The method of claim 5, wherein the client interface codec is codec of a client interface associated with the proxy service, and the media server interface codec is codec of a media server interface associated with the proxy service.

9. The method of claim 1, comprising:
communicating, using the proxy service, media between the client system and the media server.

10. The method of claim 1, comprising:
authenticating the communication initiation in response to receiving the communication initiation from the client system, the media server being selected in response to authenticating the communication initiation.

11. A system comprising:
one or more hardware processors, and
one or more computer-readable mediums storing instructions that, when executed by the one or more hardware processors, cause the system to perform operations comprising:
receiving a communication initiation from a client system;
selecting a media server based on the communication initiation;
identifying a client codec associated with the client system;
identifying a media server codec for the media server in response to identifying the client codec; and
bridging the media server and the client system with a proxy service based on the client codec and the media server codec, the proxy service being established to facilitate media communication between the client system and the media server.

12. The system of claim 11, wherein the communication initiation is received by a signaling controller that manages signaling messaging that directs media streams.

13. The system of claim 12, wherein the operations further comprise:
providing, by the signaling controller, a media server proxy parameter to the media server, the providing of the media server proxy parameter including sending a first message via a signaling interface of the signaling controller to the media server; and
providing, by the signaling controller, a client proxy parameter to the client system, the providing of the client proxy parameter including sending a second message from the signaling interface of the signaling controller to the client system.

14. The system of claim 13, wherein the operations further comprise:
identifying a media server interface of the proxy service based on the media server proxy parameter; and
identifying a media client interface of the proxy service based on the client proxy parameter.

15. The system of claim 13, wherein the proxy service communicates media with the client system using the client codec and client interface codec, and wherein the proxy service communicates media with the media server using the media server codec and media server interface codec.

16. The system of claim 13, wherein the first message comprises a signaling message using a signaling resource separate from a media resource used for media communication.

17. The system of claim 14, wherein the media client interface is usable by the client system for communicating media between the proxy service and the client system, and wherein the media server interface is usable by the media server for communicating media between the proxy service and the media server.

18. The system of claim 15, wherein the client interface codec is codec of a client interface associated with the proxy service, and the media server interface codec is codec of a media server interface associated with the proxy service.

19. The system of claim 11, wherein the operations further comprise:
communicating, using the proxy service, media between the client system and the media server.

20. A non-transitory computer-readable medium storing instructions that, when executed by one or more computer processors of a signaling controller device, cause the signaling controller device to perform operations comprising:
receiving a communication initiation from a client system;
selecting a media server based on the communication initiation;
identifying a client codec associated with the client system;
identifying a media server codec for the media server in response to identifying the client codec; and
bridging the media server and the client system with a proxy service based on the client codec and the media server codec, the proxy service being established to facilitate media communication between the client system and the media server.
